(19) United States
(12) Patent Application Publication
(10) Pub. No.: US 2006/0217021 A1
(43) Pub. Date: Sep. 28, 2006

(54) Clean-room wipers

(75) Inventor: Bradley T. Lyon, Winston Salem, NC (US)

Correspondence Address: Kramer Levin Naftalis & Frankel LLP, 919 Third Avenue, New York, NY, 10022-3582, US

(73) Assignee: Illinois Tool Woks Inc.

(21) Appl. No.: 11/086,840

(22) Filed: Mar. 22, 2005

(51) Int. Cl. B32B 23/02; D04B 21/00; D04B 21/14; B32B 5/26

(52) U.S. Cl. 442/304; 442/306; 442/318; 428/192

(57) ABSTRACT

Knitted clean-room wipers are formed in long strips with sealed borders along both side edges. The strips are fed longitudinally through a very vigorous washing process which places substantial strain on the material. After washing, the strip is cut into individual wipers whose cut edges are sealed to form individual clean-room wipers. The stretch of the wiper material in the longitudinal direction is substantially reduced so as to substantially increase the yield of acceptable wipers from the manufacturing process.

This invention relates to clean-room wipers; that is, to wipers for use in wiping surfaces and objects in clean-rooms used for semiconductor manufacturing, pharmaceutical manufacturing, computer disk drive assembly, etc.

The cleanliness requirements for objects used and people working in clean-room facilities are very stringent. In particular, cleaning materials such as wipers for wiping spills, cleaning surfaces, etc., should be very clean to avoid contamination of the work in process in the room.

Over the years, certain maximum levels of measurable contaminants have become generally accepted for defining a wiper as a “clean-room” wiper.

For example, loose particles of a size between 0.5 and 5 micrometers generally should be less than bout 30×10⁶ per square meter of wiper material, and should be well below that level for the cleanest wipers.

Similarly, counts of loose particles of a size from 5 to 100 micrometers should be less than about 0.5×10⁶ per square meter.

Loose fibers of a size greater than 100 micrometers should have a count of less than about 10⁴ per square meter.

Ionic contamination is to be controlled.

Anions requiring control include fluoride; chloride; sulfate; nitrate; nitrite; bromide and phosphate. Cations requiring control include lithium; sodium; ammonium; potassium; magnesium and calcium. In general, the concentration of each ion should be less than one part per million.

Levels of non-volatile residue in the wiper also should be low. For example, the residue level, as measured using isopropyl alcohol or de-ionized water as an extractant, should be below approximately 0.2 gram per square meter of wiper material.

As it was noted above, the most stringent requirements for clean-room wipers are well below the foregoing levels. In fact, wipers made in accordance with the present invention have levels of contaminants well below the values set forth above.

In order to provide wipers meeting the most stringent standards, several structural features have been adopted. Some of the best quality wipers are made of 100% polyester, a material which has the possibility of being extremely clean.

In a particularly advantageous prior wiper, sold by ITW Texwipe, the assignee of this patent application, the wiper is knit using polyester fibers. It has a sealed border on all four edges. The borders are formed by the application of heat and pressure to the border areas. This melts and fuses the thermoplastic fibers together and thus binds the cut ends of the fibers so that the fabric will emit fewer loose particles. The fused border wiper is shown in U.S. Pat. No. 4,888,229, the disclosure of which hereby is incorporated herein by reference.

Despite the general excellence of the sealed border wiper described above, the extremely stringent requirements for cleanliness cause problems in manufacturing which result in a substantial percentage of the wipers having to be scrapped. This is believed to be due to the very vigorous washing requirements needed to make the final products very, very clean.

A particularly advantageous manufacturing process is used. The wiper material is formed into long strips with fused borders on the side edges. The strips are fed longitudinally through washing apparatus which washes the material prior to it being cut into individual wipers. The cut ends then are sealed with a fused border in order to provide finished wipers.

In accordance with the invention, it has been recognized that the strain placed on the wiper material in the washing processes used is so great that the material often tears along the borders, thus causing the wipers to be rejected and scrapped.

Accordingly, it is an object of the present invention to provide an improved wiper which better withstands the strenuous washing process for such wipers.

Stated another way, it is an object of the invention to provide a wiper construction in which the yield from the production process used in making the wiper is significantly improved.

It is another object of the invention to provide a sealed-border clean-room wiper which meets all of the requirements of cleanliness for such wipers, and yet is relatively less costly to manufacture.

It is a further object of the invention to provide such a wiper in which the time required to produce a given number of such wipers is significantly reduced.

In accordance with the present invention, the foregoing objects are met by the provision of an elongated knitted clean-room wiper strip with sealed longitudinal edges and a significantly reduced longitudinal stretch. Preferably, the stretch should be less than 90% in the longitudinal direction. This change has been found to significantly reduce the percentage of wipers scrapped.

Reducing the longitudinal stretch to a level even lower than 90% is desirable, but reducing it below about 50% can be deleterious to other desirable qualities of the wiper. Therefore, a reduction to a range of bout 50% to 90%, preferably about 80%, is preferred.

After the washing process, the wiper strip is cut into rectangles or squares, and the cut ends are sealed.

The material savings due to improved yields reduces manufacturing costs.

Because the yield of the manufacturing process is increased, the average time needed to make a given number of wipers if reduced. This further reduces manufacturing costs.

The foregoing and other objects and advantages of the invention will be set forth in or apparent from the following description and drawings.

### IN THE DRAWINGS

FIG. 1 is a perspective view of a clean-room wiper constructed in accordance with the present invention;

FIG. 2 is a top plan view of a section of a strip of wiper material constructed in accordance with the invention; and

FIG. 3 is a photomicrograph of a section of the wiper material of the present invention shown next to a section of a prior art wiper of comparable construction.

### Finished Wiper

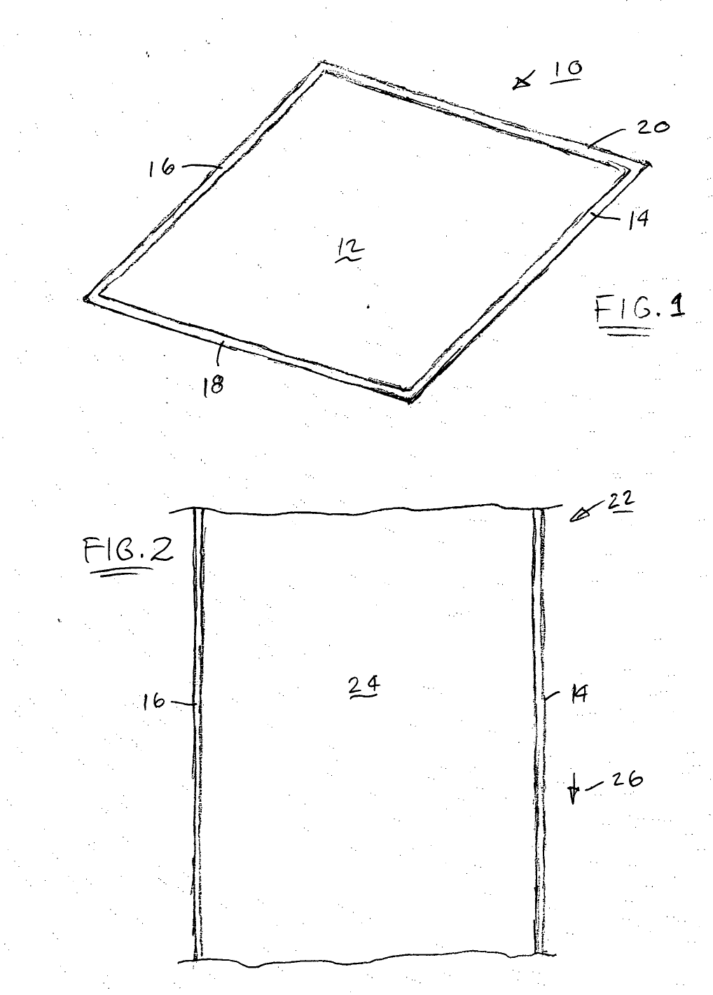

FIG. 1 is a perspective view of a finished clean-room wiper 10 constructed in accordance with the invention. The wiper 10 has a knitted body portion 12 with sealed borders 14, 16, 18, and 20 at each of the four edges of the wiper.

As it is well known, and as it is described in U.S. Pat. No. 4,888,229, the sealed border for the wiper is formed by the application of heat and pressure to the edges of the wiper to fuse the cut ends of the thermoplastic fibers of which the wiper is knitted so as to prevent them from issuing large numbers of loose particles. The wiper is thoroughly washed as one of the final steps in the manufacturing process, so as to give the wiper the degree of cleanliness which it needs to meet the requirements of the clean-room in which it is intended to be used.

The wiper 10 preferably is square. For example, the wiper can be square of approximately 9 inches by 9 inches. However, it can have a rectangular or other shape, as desired.

### Wiper Strip

FIG. 2 shows a section 22 of a long wiper strip. The section 22 is cut from a relatively long knitted strip having a body portion 24 with two side borders 16 and 14 extending along the entire length of the strip. The strip 22 is formed as an intermediate product which is wound into rolls for use in a vigorous washing process.

In the washing process, the strip 22 is fed longitudinally, in the direction indicated by the arrow 26, through a washing apparatus (not shown) which exposes the strip 22 to relatively high levels of mechanical stress due to the extreme vigor of the washing process. In general, the vigor of the washing process determines the cleanliness of the resulting wiper. Therefore, as the cleanliness increases, there is an increase in the stresses created in the wiper material.

### Knitted Fabric

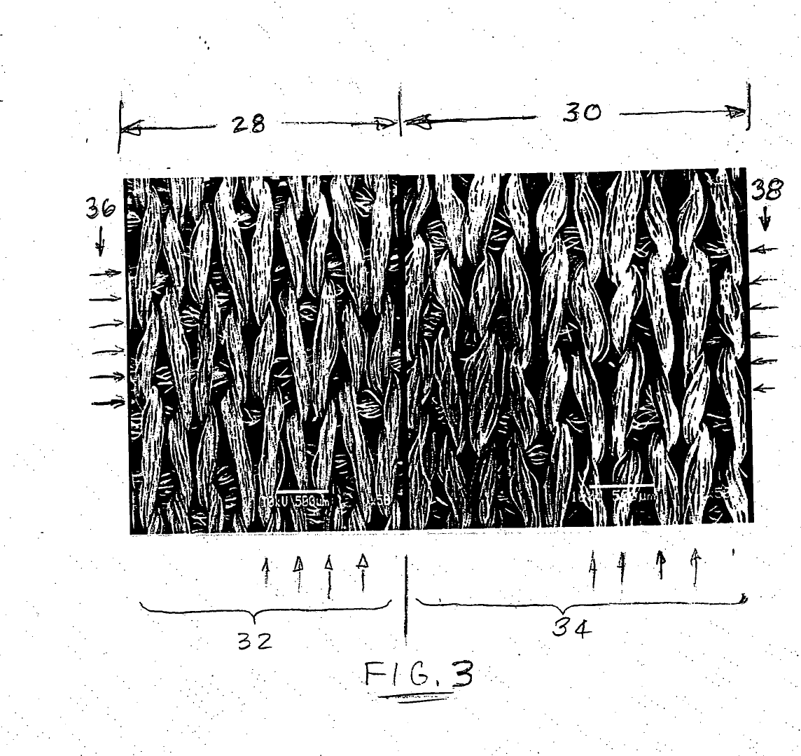

FIG. 3 is a pair of electron microscope photomicrographs showing the knitted fabric of a prior wiper, at 28, side-by-side with a photomicrograph of the wiper material in accordance with the present invention, shown at 30. Both show the fabric at a magnification of 50.

The knit pattern in both cases is a double-knit interlock pattern in which courses 32 and 34 extend longitudinally of the strip, and wales 36 and 38 extend perpendicularly to the courses.

In accordance with the present invention, it has been recognized by the inventor that the yield of usable wipers from the manufacturing process can be significantly increased by the relatively simple expedient of tightening the knit in the longitudinal direction of the strip 22 and thus reducing its stretch in the longitudinal direction.

In the past, the longitudinal stretch of the material was well in excess of 100%, usually being in excess of 120%. The longitudinal stretch of the material of the present invention has been reduced to a range of from 90% to 50%, preferably in the vicinity of 80%.

Preferably, the wipers are made of a yarn comprising polyester fibers, single layer, 36 fibers, 70 denier.

Preferably, the material is knitted on a circular knitting machine, 28 cut, 30 inch cylinder interlocking type.

A wide variety of methods are known to those skilled in the art which would be suitable for tightening the knit in the longitudinal direction (that is, in the direction of the courses 34). However, it is preferred to achieve the tightening by reducing the length of the yarn in the courses by about 8% (eight percent) before the “greige” or raw material is finished. Finishing usually includes scouring, bleaching, dyeing, and drying. This is done, preferably, prior to formation of the two longitudinal side borders 14 and 16, shown in FIG. 2.

It can be seen in FIG. 3 that the spacing between adjacent wales (in the vertical direction) is slightly smaller in the material 30 than in the prior material 28, reflecting the tightening of the knit in the material 30.

By reducing the longitudinal stretch in the material by only a moderate amount, there is little or no change discernable in the absorptiveness, softness, etc., in the wiper material. Any such changes can be readily compensated for, as is known by those skilled in the art, by making moderate adjustments in the finishing of the material.

The term “stretch”, as it is used in this patent application, refers to the elongation of the material at the first break, as specified in ASTM D5035-95 (reapproved 2003), entitled: “Standard Test Method For Breaking Force And Elongation Of Textile Fabrics (Strip Method)”.

As a result of the use of the invention, the average percentage of scrap in the manufacturing process has been reduced by as much as 40% (forty percent) or more. Thus, a significant savings in material, time and, hence, cost of manufacture has been achieved.

The above description of the invention is intended to be illustrative and not limiting. Various changes or modifications in the embodiments described may occur to those skilled in the art. These can be made without departing from the spirit or scope of the invention.

What is claimed is:

1. A clean-room wiper strip, said wiper strip comprising
an elongated body made of knitted synthetic fibers and having two opposed side edges with a fused border along each of said edges,
said body having a knitting pattern consisting of wales and courses of multifilament yarn, said courses extending in the longitudinal direction of said elongated body,
the percentage stretch of said body in said longitudinal direction being less than approximately 90% (ninety percent).

2. A wiper strip as in claim 1 in which said elongated body contains very low levels of loose particles and metallic ions, and said percentage stretch is greater than about 50%.

3. A wiper strip as in claim 2 in which the count in said body of loose particles of between about 0.5 to 5.0 micrometers is less than approximately 30×10⁶ per square meter.

4. A wiper strip as in claim 2 in which the count in said body of loose particles of between about 5 to 100 micrometers is less than approximately 30×10⁶ per square meter.

5. A wiper strip as in claim 2 in which the count in said body of loose particles of greater than 100 micrometers size is less than approximately 10⁴ per square meter.

6. A wiper strip as in claim 2 in which the concentration of each anion and cation in said body is less than approximately 1 part per million.

7. A wiper strip as in claim 2 in which the non-volatile residue in said body, measured using isopropyl alcohol or deionized water as the extractant solution, is less than approximately 0.2 gram per square meter.

8. A clean-room wiper having very low levels of loose particles and metallic ions, said wiper comprising
a rectilinear body made of knitted synthetic fibers and having four edges, each with a fused border along its length,
said body having a knitting pattern consisting of wales and courses of multifilament yarn,
said courses extending in a first direction and said wales extending in a second direction perpendicular to said first direction,
the percentage stretch in the direction of said courses being less than approximately 90% (ninety percent).

9. A wiper as in claim 8 in which the count in said body of loose particles of between about 0.5 to 5.0 micrometers is less than approximately 30×10⁶ per square meter.

10. A wiper as in claim 8 in which the count in said body of loose particles of between about 5 to 100 micrometers is less than approximately 0.5×10⁶ per square meter.

11. A wiper as in claim 8 in which the count in said body of loose fibers of greater than 100 micrometers size is less than approximately 10⁴ per square meter.

12. A wiper as in claim 8 in which the concentration of each cation and each anion in said body is less than approximately 1 part per million.

13. A wiper as in claim 8 in which the non-volatile residue in said body, measured using isopropyl alcohol or deionized water as the extractant solution, is less than approximately 0.2 gram per square meter.

14. A wiper as in claim 8 in which said synthetic fibers are made of polyester.

15. A wiper as in claim 14 in which said fibers form a yarn having 36 fibers, 70 denier, single-ply.
